(19) United States
(12) Patent Application Publication
(10) Pub. No.: US 2005/0026512 A1
(43) Pub. Date: Feb. 3, 2005

(54) One piece stamped compressible spring pin

(76) Inventor: Jack Seidler, Flushing, NY (US)

Correspondence Address: DARBY & DARBY P.C., P. O. BOX 5257, NEW YORK, NY, 10150-5257, US

(21) Appl. No.: 10/682,792

(22) Filed: Oct. 9, 2003

Related U.S. Application Data
(63) Continuation-in-part of application No. 10/634,632, filed on Aug. 1, 2003, now abandoned.

(51) Int. Cl. H01R 4/48

(52) U.S. Cl. 439/819

(57) ABSTRACT

A one-piece, stamped compressible spring pin is described. The spring pin is formed by stamping a predetermined shape from a single piece of sheet metal. The spring pin comprises outer shells, a central pin, and a base which are all integrally formed. The central pin extends perpendicular from the base and is formed to create a means for imparting spring characteristics to the pin. The outer shells extend from the base and are cup shaped. The outer shells are bent along a line adjacent the base to surround the central pin.

### CLAIM OF PRIORITY

This patent application claims the benefit of priority, under 35 U.S.C. § 120, as a continuation-in-part of U.S. patent application Ser. No. 10/634,632, filed Aug. 1, 2003, entitled “ONE PIECE STAMPED COMPRESSIBLE SPRING PIN” which is herein incorporated by reference in its entirety.

### FIELD OF INVENTION

The present invention relates to pins for establishing electronic connections, and more specifically for compressible spring pins used in establishing repeatable electronic connections.

### BACKGROUND OF THE INVENTION

Compressible spring pins are used as electrical contacts in many industrial and electronic applications. These pins are required to have a long lifetime e, and a safe and consistent contact performance. There are many electronic devices, such as ATE used for testing flash memories which require thousands of pins, and as use and complexity of electronic circuitry proliferates, the demand for pins of this type are substantially increasing. A conventional spring pin requires a barrel which houses a spring and plunger, as well as (in some instances) a retainer plug. These pieces are individually machined, plated (usually gold) and then assembled. As a result of the nature of its design and manufacturing processes, the end product is quite expensive.

In particular, there is a need for a compressible spring pin which can be manufactured at low cost, with adequate functional performance to meet most of industries mechanical and electrical requirements. The present invention satisfies these and other needs, as set forth in the following description

### SUMMARY OF THE INVENTION

In accordance with one aspect of the invention, a one piece compressible spring pin is formed from a single piece of sheet metal. A predetermined shape is stamped from the piece of sheet metal and formed into the spring pin. The spring pin comprises a center pin surrounded by outer shells and a base, all integrally formed from the sheet metal. The center pin is resiliently compressible to impart spring characteristics to the pin.

The center pin comprises a resilient central portion which, in accordance with an aspect of the invention, is rippled with a multiplicity of waves. The resilient central portion can also be formed using any of a different number of configurations that impart spring characteristics to the center pin.

In accordance with a further embodiment, the center pin is comprised of a contact point and a cylindrical portion at an end away from the base. The contact point and the base may be selectively plated.

These and other aspects, features, steps and advantages can be further appreciated from the accompanying drawing Figures and description of certain illustrative embodiments.

### BRIEF DESCRIPTION OF THE DRAWING FIGURES

FIGS. 1A and 1B are perspective views of a one-piece stamped, compressible spring pin in accordance with an embodiment of the invention shown in different stages of closing done by the die;

FIG. 1C is an exploded perspective view of the spring pin shown in FIG. 1A;

FIGS. 2A-2C are plan views of the spring pin shown in FIG. 1A, at different stages of the manufacturing process;

FIGS. 3A-3F are side elevation views of the spring pin shown in FIG. 1A, at different stages of the manufacturing process; and

FIGS. 4-6 are perspective views of the spring pin shown in FIG. 1A, depicting alternative configurations.

### DETAILED DESCRIPTION OF THE ILLUSTRATIVE EMBODIMENTS

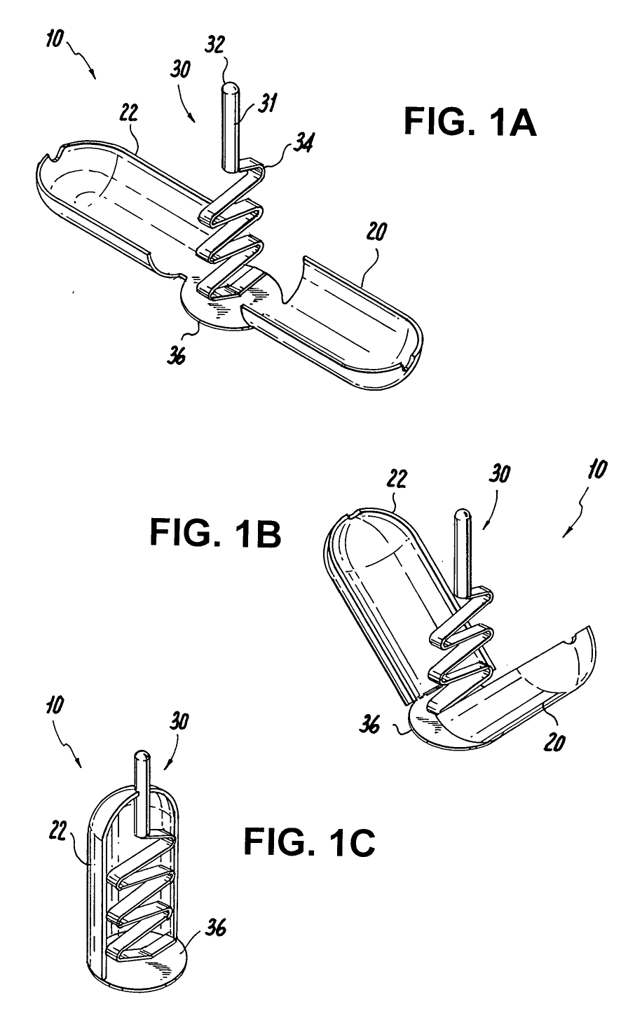

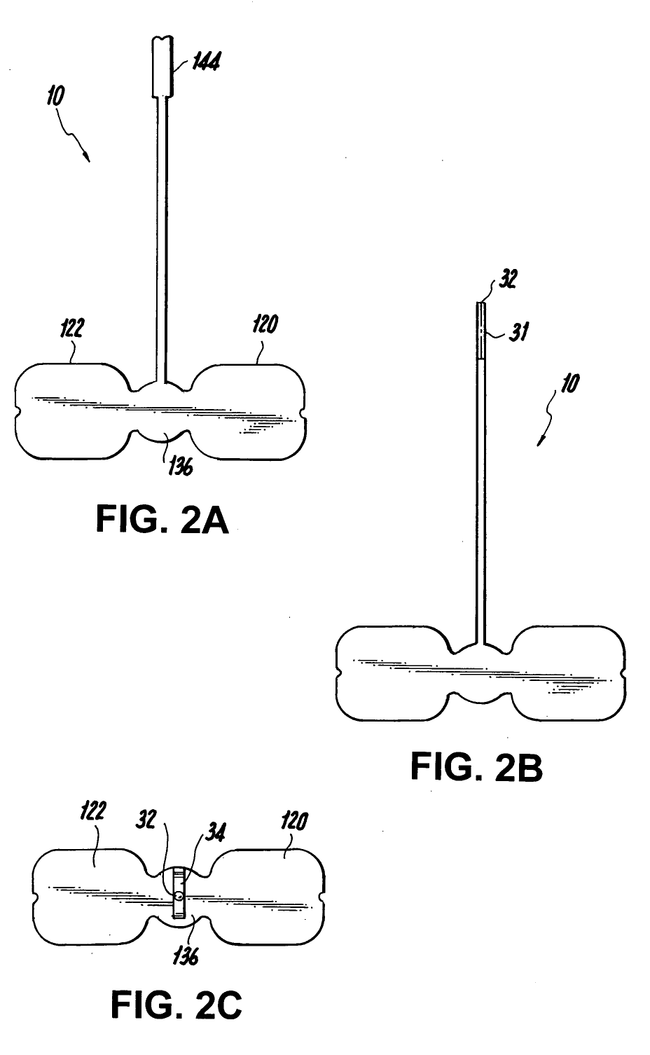

The present invention relates to a one-piece stamped, compressible spring pin. According to one embodiment of the present invention, as shown in FIGS. 1A-1C, the spring pin 10 is formed from a single piece of resilient sheet metal and comprises conductive outer shells 20, 22, a pin 30, and base 36. The pin 30 is comprised of a contact point 32, and a central portion 34 between the base 36 and the contact point. The spring pin includes a cylindrical portion 31 adjacent to the contact point 32, and a resilient segment 34 between the cylindrical portion and the base 36. The resilient segment 34 imparts spring characteristics to the pin 30.

Because the spring pin 10 is formed from a single piece of sheet metal, all components are integrally formed during the stamping process. The material from which the spring pin of the present invention is formed can be a resilient sheet metal (such as beryllium copper or phosphor bronze) or any other conductive material that can be stamped and formed into spring pin 10.

The spring pin of the present invention is formed by a progressive stamping process in which areas of the sheet metal are removed, and then selected portions are bent at successive forming stations. Each forming station consists of suitable punches and dies to result in the arrangement shown and described herein.

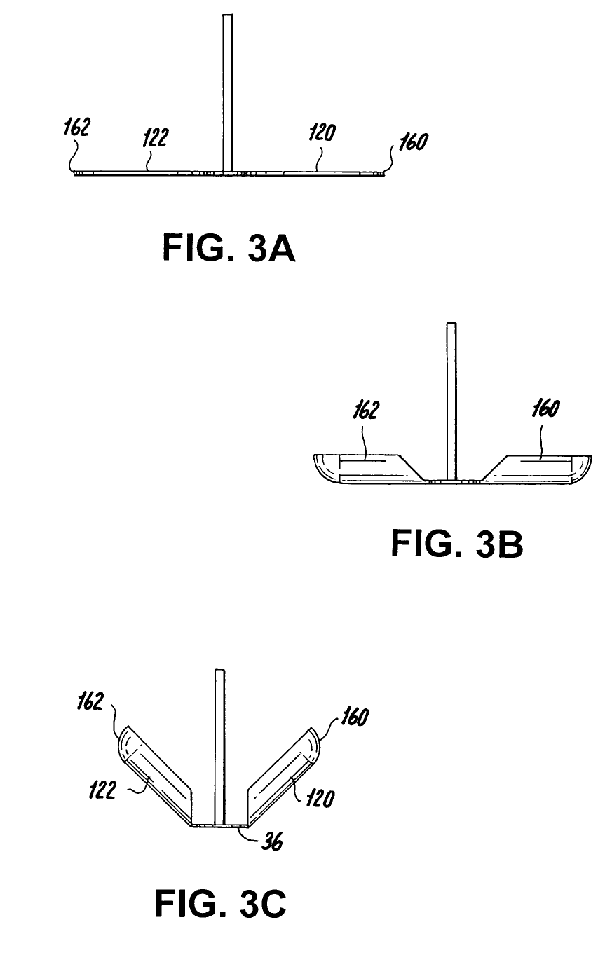

The stamped spring pin 10, as depicted in FIG. 2A, is cut out of a single sheet of metal utilizing a stamping process. The stamping process cuts a central area 136 having two stamped wings 120, 122 extending from opposite sides, and a substantially orthogonal extension 130, which extends from an edge of the central area 136 midway between the two wings 120, 122. At an end of the orthogonal extension 130 away from the central area 136, is a broadened flap 144.

FIG. 2B depicts the spring pin after the broadened flap 144 has been rolled together to form both the contact point 32 and the adjacent cylindrical portion 31 of pin 30. A portion of orthogonal extension 130 is transformed into the resilient segment 34.

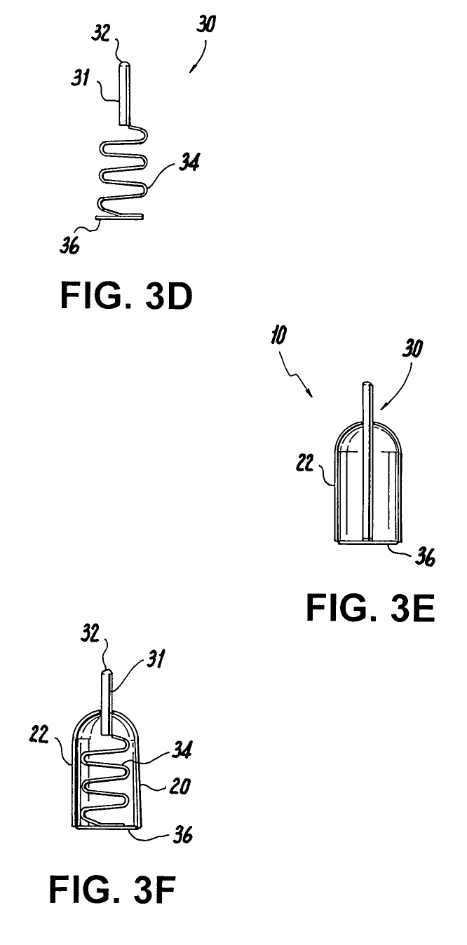

Preferably, resilient segment 34 is formed, by a bending process, into a multiplicity of waves, as depicted in FIG. 3D. These waves impart spring characteristics to the pin 30. FIG. 2C is a top plan view of spring pin 10, as depicted in the elevation view of FIG. 3D.

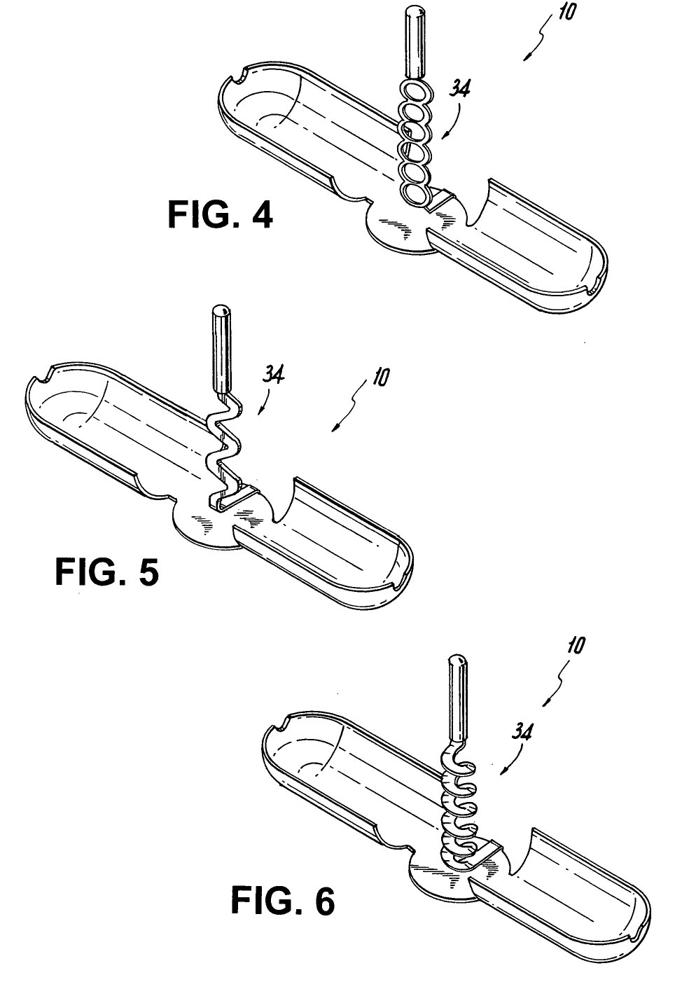

Alternatively, resilient segment 34 can be formed using any of a different number of configurations that impart spring characteristics to the center pin. By way of example, FIG. 4 depicts resilient segment 34 formed as a series of links. In operation, compressing contact point 32 against a surface will cause the links to expand slightly in a transverse direction, but because of its resilient properties an opposing force will be created causing contact point 32 to maintain a secure contact against the surface. As depicted in FIG. 5, resilient segment 34 can be formed as a series of switchbacks which impart spring characteristics to the center pin. With reference to FIG. 6, resilient segment 34 can be formed as a spiral spring formed by bending orthogonal extension 130 spirally about its axis. The resilient segment can be formed into any configuration, known to those skilled in the art, which imparts spring characteristics to the center pin.

FIG. 3A through FIG. 3C depict, in elevational view, the spring pin of the present invention in successive stages of the progressive stamp and die process used to manufacture the pin. FIG. 3A depicts the stamped spring pin 10 after orthogonal extension 130 is bent perpendicular to central area 136. Also shown in FIG. 3A are outer edge portions 160, 162 of the stamped wings 120, 122. FIG. 3B shows the outer edge portions 160, 162 bent upwards to begin the formation of the conductive outer shells 20, 22. Referring to FIG. 3C, the stamped wings 120, 122 are bent to fully define the outer shells from the base 36. After the outer shells 20, 22 are completely formed, as described below, the shells are bent to close around the pin 30 as illustrated in FIGS. 3E and 3F (front and side elevation views, respectively).

With reference to FIGS. 1A through 1C, the conductive outer shells 20, 22 are cup-shaped. The outer shells 20, 22 are drawn into a cup-shape during the progressive die process, which uses sequential sets of punches and dies. The manufacture of a cup-shape from a single piece of flat sheet metal, as disclosed herein to form the conductive outer shells 20, 22, is well known in the art of progressive stamp and die processes.

The one-piece stamped, compressible spring pin 10 of the present invention can be plated with a material to enhance its conductivity. Alternatively, particular regions of the spring pin, e.g., the outer surface of base 36 and the tip of contact point 32 may be selectively plated.

Thus, while there have been shown, described, and pointed out fundamental novel features of the invention as applied to a preferred embodiment, it will be understood that various omissions, substitutions, and changes in the form and details of the devices illustrated, and in their operation, may be made by those skilled in the art without departing from the spirit and scope of the invention. For example, it is expressly intended that all combinations of those elements steps which perform substantially the same, function in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

1. A one-piece stamped compressible spring pin comprising:
at least one outer shell;
a base; and
a pin comprising:
a contact point at an end opposite the base, and a central portion located between the base and the contact point;
a means for imparting spring characteristics to the central portion;
wherein the at least one outer shell, base, and pin are integrally formed from a single piece of sheet metal, and the outer shell and pin extend from separate edges of the base.

2. The spring pin of claim 1, wherein the means for imparting spring characteristics comprises a multiplicity of waves.

3. The spring pin of claim 1, wherein the means for imparting spring characteristics comprises a series of links.

4. The spring pin of claim 1, wherein the means for imparting spring characteristics comprises a series of switchbacks.

5. The spring pin of claim 1, wherein the means for imparting spring characteristics comprises a spiral spring.

6. The spring pin of claim 1, wherein the sheet metal is a conductive material.

7. The spring pin of claim 6, wherein the sheet metal is at least one of beryllium copper and phosphor bronze.

8. The spring pin of claim 1, wherein at least the contact point is plated.

9. The spring pin of claim 1, wherein the pin further comprises a broadened flap at an end opposite the base.

10. The spring pin of claim 9, wherein the broadened flap is rolled to form the contact point.

11. A method of making a one-piece stamped compressible spring pin comprising the steps of:
stamping a predetermined shape out of a single piece of sheet metal;
wherein the predetermined shape has at least one wing, a central area, and a substantially orthogonal extension protruding from the central area;
stamping clearance cuts and through holes in the predetermined shape;
forming a portion of the orthogonal extension to create a means for imparting spring characteristics to the orthogonal extension;
forming a cup-shape in the at least one wing to produce an outer shell;
bending the orthogonal extension to an angle perpendicular to the central area; and
bending the predetermined shape to at least partially cover the orthogonal extension with the outer shell.

12. The method of clam 11 further comprising the step of:
plating at least a portion of the orthogonal extension.

13. The method of claim 11, wherein the predetermined shape further comprises two wings.

14. The method of claim 11, wherein the means for imparting spring characteristics comprises a multiplicity of waves.

15. The method of claim 11, wherein the means for imparting spring characteristics comprises a series of links.

16. The method of claim 11, wherein the means for imparting spring characteristics comprises a series of switchbacks.

17. The method of claim 11, wherein the means for imparting spring characteristics comprises a spiral spring.
